(19) United States
(12) Patent Application Publication
(10) Pub. No.: US 2022/0262554 A1
(43) Pub. Date: Aug. 18, 2022

(54) Multi-Stable Solenoid Having an Intermediate Pole Piece

(71) Applicant: HUSCO Automotive Holdings LLC, Waukesha, WI (US)

(72) Inventor: Matthew Pellmann, Summit, WI (US)

(21) Appl. No.: 17/672,221

(22) Filed: Feb. 15, 2022

Related U.S. Application Data
(60) Provisional application No. 63/149,605, filed on Feb. 15, 2021.

(51) Int. Cl. H01F 7/02; H01F 7/16; H01F 7/126

(52) U.S. Cl. CPC H01F 7/0221; H01F 7/126; H01F 7/1646

(57) ABSTRACT

A multi-stable solenoid includes a housing defining a first end and an opposing second end, a wire coil arranged within the housing and defining an inner coil plane defined along a radially innermost diameter of the wire coil, a first pole piece arranged adjacent to the first end of the housing, a second pole piece arranged adjacent to the second end of the housing, and an intermediate pole piece arranged axially between the first pole and the second pole. The intermediate pole piece extends radially outwardly past the inner coil plane to an outer surface. The solenoid further includes a permanent magnet arranged adjacent to the intermediate pole piece, and an armature slidably arranged within the housing and movable between two or more stable positions. Selective energization of the wire coil is configured to move the armature between the two or more stable positions.

### CROSS-REFERENCES TO RELATED APPLICATIONS

This application is based on, claims priority to, and incorporates herein by reference in its entirety, U.S. Provisional Patent Application No. 63/149,605, filed on Feb. 15, 2021, and entitled “Multi-Stable Solenoid Having an Intermediate Pole Piece”

### STATEMENT REGARDING FEDERALLY SPONSORED RESEARCH

Not Applicable.

### BACKGROUND

Multi-stable solenoids typically include a wire coil arranged around a movable armature. When a current is applied to the wire coil, a magnetic field is generated that can actuate (i.e., move) the movable armature from one stable position to another.

### SUMMARY OF THE INVENTION

The present disclosure provides a multi-stable solenoid that includes an intermediate pole piece arranged between a first pole piece and a second pole piece.

In one aspect, the present disclosure provides a multi-stable solenoid. The multi-stable solenoid includes a housing defining a first end and an opposing second end, a wire coil arranged within the housing and defining an inner coil plane defined along a radially innermost diameter of the wire coil, a first pole piece arranged adjacent to the first end of the housing, a second pole piece arranged adjacent to the second end of the housing, and an intermediate pole piece arranged axially between the first pole and the second pole. The intermediate pole piece extends radially outwardly past the inner coil plane to an outer surface. The solenoid further includes a permanent magnet arranged adjacent to the intermediate pole piece, and an armature slidably arranged within the housing and movable between two or more stable positions. Selective energization of the wire coil is configured to move the armature between the two or more stable positions.

According to another aspect, the present disclosure provides a multi-stable including a housing, a wire coil arranged within the housing and defining an inner coil plane defined along a radially innermost diameter of the wire coil, a first pole piece arranged at least partially within the housing, a second pole piece arranged at least partially within the housing, a permanent magnet arranged within the housing, and an intermediate pole piece arranged axially between the first pole piece and the second pole piece and axially aligned with the permanent magnet. The intermediate pole piece defines a radially outermost plane that is arranged radially outwardly relative to the inner coil plane. The solenoid further includes an armature arranged within the housing and slidably movable between at least a first stable position and a second stable position. Selective energization of the wire coil is configured to move the armature between the first stable position and the second stable position.

According to another aspect, the present disclosure provides a multi-stable solenoid including a housing defining a first end and an opposing second end, a wire coil arranged within the housing, a first pole piece arranged adjacent to the first end of the housing, a second pole piece arranged adjacent to the second end of the housing, and an intermediate pole piece arranged axially between the first pole and the second pole. The intermediate pole piece defines a T-shaped profile formed by a first axial protrusion, a second axial protrusion, and a radial flange. The solenoid further includes a permanent magnet arranged between the first pole and the second pole and axially aligned with the intermediate pole piece, and an armature movable between two or more stable positions. Selective energization of the wire coil is configured to actuate the armature between the two or more stable positions.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a cross-sectional view of a multi-stable solenoid with an armature in a first stable position according to one aspect of the present disclosure.

FIG. 2 is a cross-sectional view of the multi-stable solenoid of FIG. 1 with the armature in a second stable position.

FIG. 3 is a cross-section view of the multi-stable solenoid of FIG. 1 with an alternative orientation between a permanent magnet and an intermediate pole piece.

FIG. 4 is a cross-sectional view of a multi-stable solenoid with an armature in a first stable position according to one aspect of the present disclosure.

FIG. 5 is a cross-sectional view of the multi-stable solenoid of FIG. 4 with an armature in a second stable position.

FIG. 6 is a cross-sectional view of the bi-stable solenoid of FIG. 5 taken along line 6-6.

### DETAILED DESCRIPTION OF THE INVENTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use herein of the term “axial” and variations thereof refers to a direction that extends generally along an axis of symmetry, a central axis, or an elongate direction of a particular component or system. For example, an axially-extending structure of a component may extend generally along a direction that is parallel to an axis of symmetry or an elongate direction of that component. Similarly, the use herein of the term “radial” and variations thereof refers to directions that are generally perpendicular to a corresponding axial direction. For example, a radially extending structure of a component may generally extend at least partly along a direction that is perpendicular to a longitudinal or central axis of that component. The use herein of the term “circumferential” and variations thereof refers to a direction that extends generally around a circumference or periphery of an object, around an axis of symmetry, around a central axis, or around an elongate direction of a particular component or system.

In general, multi-stable solenoids can include an armature movable between two or more stable positions. For example, an armature within a bi-stable solenoid is movable between two stable positions, a tri-stable solenoid is movable between three stable positions, and so on. In the non-limiting example of a bi-stable solenoid, a current may be applied to the wire coil in a first direction with a magnitude sufficient to actuate an armature from a first stable position to a second stable position. The armature may remain in the second stable position until a current is applied to the wire coil in a second direction with a magnitude sufficient to actuate the armature from the second stable position back to the first stable position. Again, the armature may remain in the first stable position until the current is applied to the wire coil in the first direction with a sufficient magnitude. When the armature is in one of the stable positions, no power or current needs to be applied to the wire coil to keep the armature in a stable position.

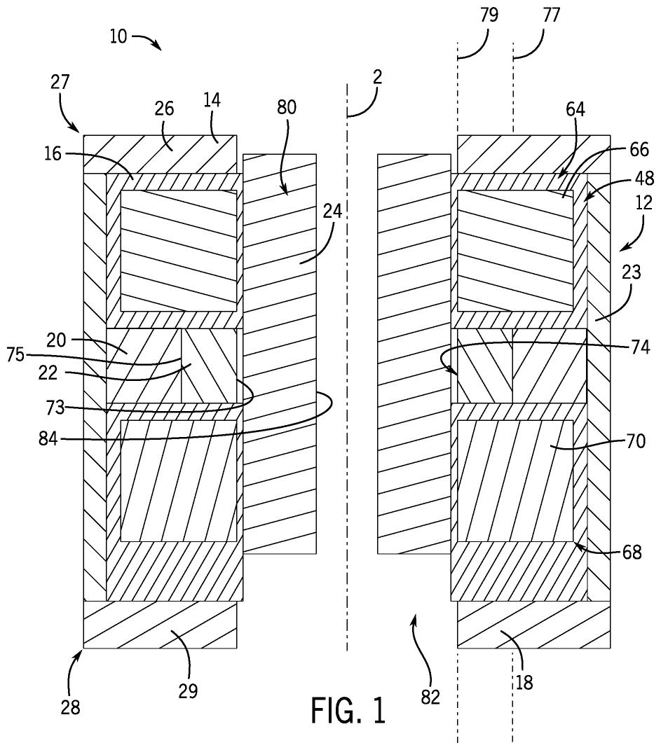

FIG. 1 illustrates a multi-stable solenoid 10 according to one aspect of the present disclosure. The multi-stable solenoid 10 can include a housing 12, a bobbin 16, a permanent magnet 20, an intermediate pole piece 22, and an armature 24. The components of the solenoid 10 may be aligned along a central axis 2. In some non-limiting examples, the components of the solenoid 10 may be shaped generally annularly about the central axis 2.

In the illustrated non-limiting example, the housing 12 can define a generally hollow, cylindrical shape and can include a cylindrical sleeve 23 and a first flange 26 arranged at a first end 27 of the housing 12. Opposite the first end 27, the housing 12 can include a second flange 29 arranged at a second end 28 of the housing 12. In the illustrated non-limiting example, the housing 12 can define a first pole piece 14 at the first end 27 and a second pole piece 18 at the second end 28. For example, the first flange 26 can define the first pole piece 14 and can be fabricated from a magnetic material (e.g., magnetic steel, iron, nickel, etc.). Similarly, the second flange 29 can define the second pole piece 18 can be fabricated from a magnetic material (e.g., magnetic steel, iron, nickel, etc.). In some embodiments, the cylindrical sleeve 23 can be fabricated from a magnetic material (e.g., magnetic steel, iron, nickel, etc.).

The bobbin 16 can be fabricated from a non-magnetic material (e.g., plastic) and can define a first bobbin portion 64 that can be arranged adjacent to the first end 27 of the housing 12. The first bobbin portion 64 can define a generally annular shape. The first bobbin portion 64 can include a first coil bay 66 of a wire coil 48, the wire coil 48 being wound around the first bobbin portion 64. The bobbin 16 can also define a second bobbin portion 68 arranged adjacent to the second end 28 of the housing 12. The second bobbin portion 68 can define a generally annular shape and can include second coil bay 70 of the wire coil 48, the wire coil 48 also being wound around the second bobbin portion 68.

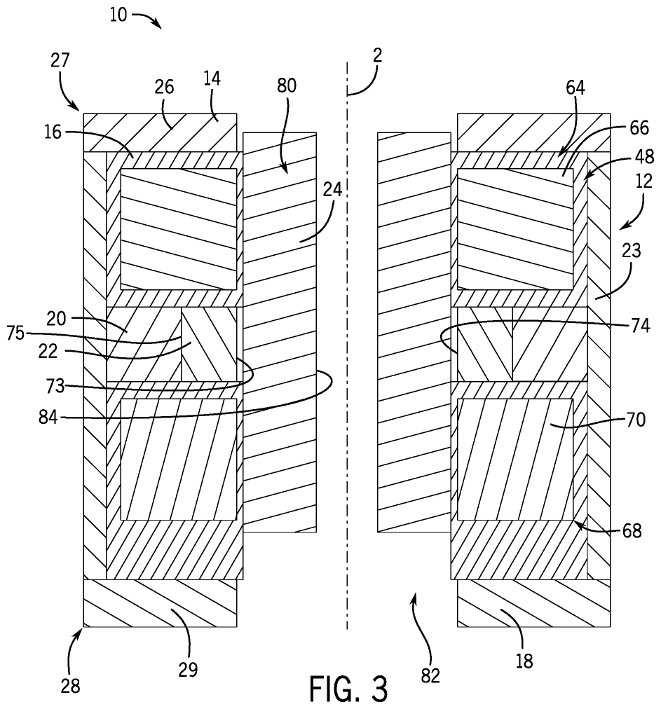

The permanent magnet 20 can define a generally annular shape and can be disposed within the housing 12 between the first bobbin portion 64 and the second bobbin portion 68. That is, the first coil bay 66 and the second coil bay 70 can be axially separated forming an axial gap in the bobbin 16. The permanent magnet 20 can be arranged between within the axial gap between the first coil bay 66 and the second coil bay 70. In the illustrated non-limiting example, the permanent magnet 20 is arranged radially outward from the intermediate pole piece 22, and in series with the permanent magnet (i.e., in the magnetic circuit all of the magnetic flux passing through the intermediate pole piece 22 also flows through the permanent magnet 20, except for loss effects). In other non-limiting examples, the relative radial orientation of between the permanent magnet 20 and the intermediate pole piece 22 may be varied. For example, the permanent magnet 20 may be arranged radially inwardly relative to the intermediate pole piece 22 (see FIG. 3).

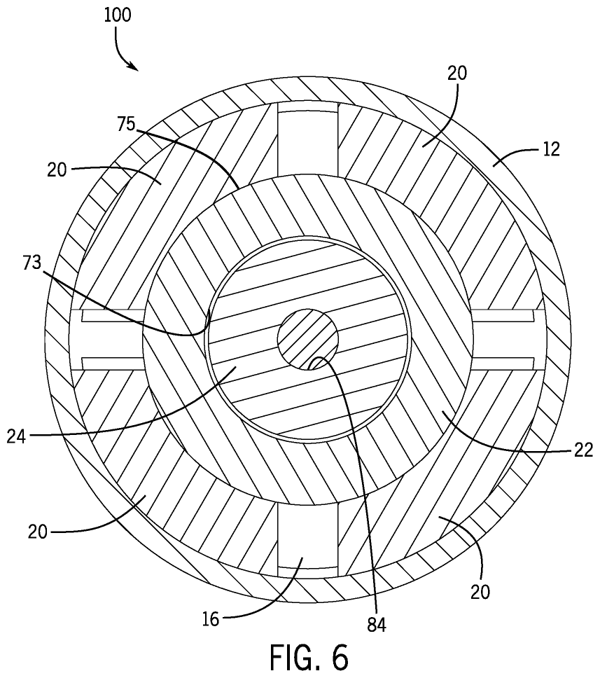

In the illustrated arrangement, the permanent magnet 20 is radially charged. That is, the north and south poles of the permanent magnet 20 may be aligned in a radial direction (e.g., a direction perpendicular to the central axis 2). In some non-limiting examples, the multi-stable solenoid 10 can include a plurality of permanent magnets (see FIG. 6) arranged in a circumferential pattern within the housing 12. In the illustrated non-limiting example, a portion of the axial length of the permanent magnet 20 axially overlaps with a portion of the axial length of the intermediate pole piece 22. That is, the permanent magnet 20 may be arranged at an axial location along the central axis 2 so that the axial length defined by the permanent magnet 20 overlaps with or is arranged at the same axial location as at least a portion of the intermediate pole piece 22.

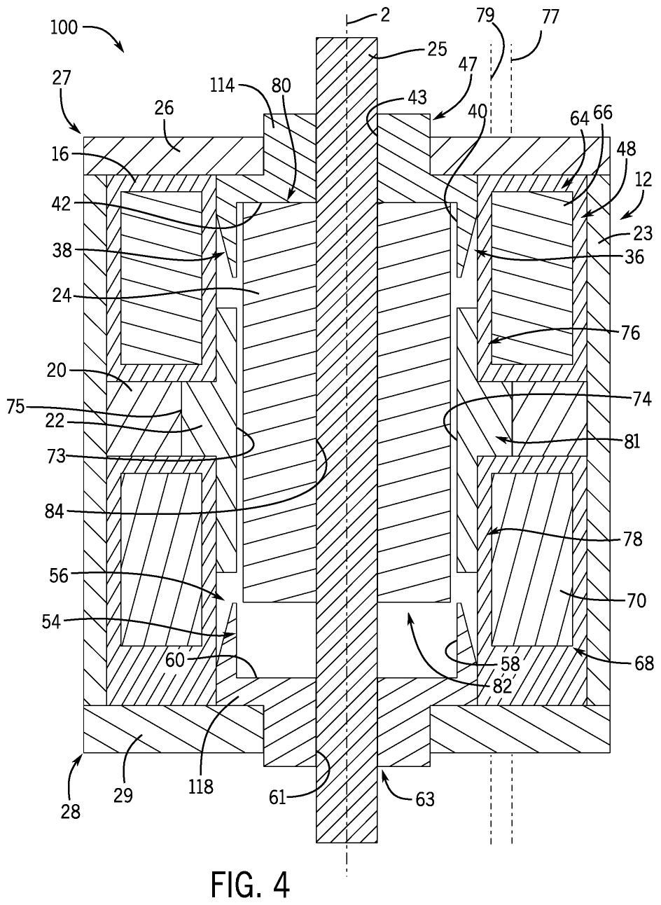

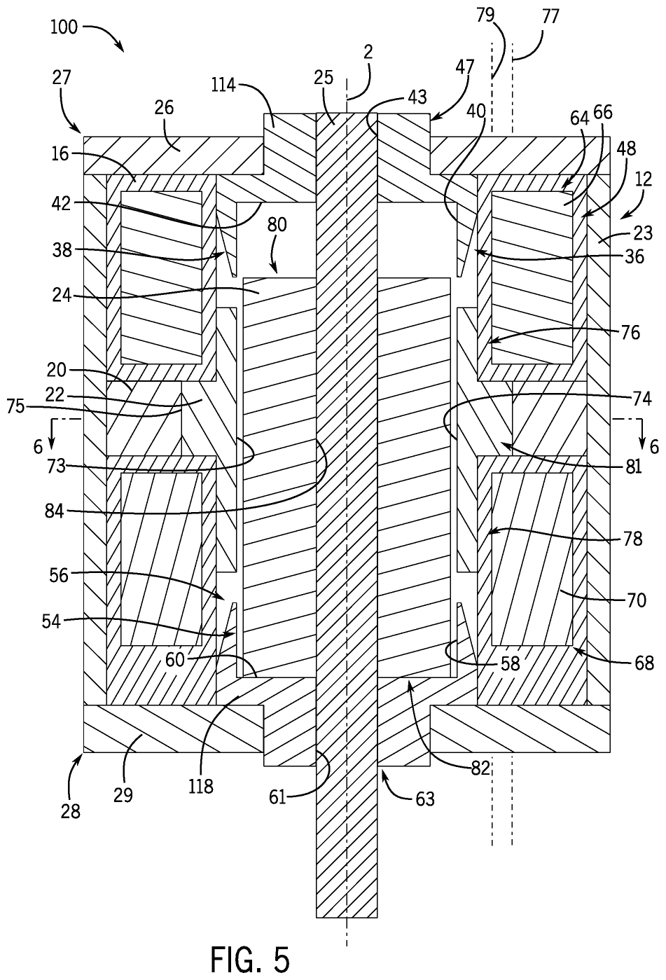

With continued reference to FIG. 1, the intermediate pole piece 22 can be fabricated from a magnetic material (e.g., magnetic steel, iron, nickel, etc.). As illustrated in FIG. 1, the intermediate pole piece 22 can define a generally annular shape and can be disposed within the housing 12 axially between the first pole piece 14 and the second pole piece 18. In the illustrated non-limiting example, at least a portion of the intermediate pole piece 22 can be arranged between the axial gap formed between the first coil bay 66 and the second coil bay 70. The intermediate pole piece 22 includes an inner surface 73 that defines an armature opening 74 within which the armature 24 extends through. The intermediate pole piece 22 can define a rectangular profile in cross-section, although other profiles are also possible (e.g., FIGS. 4-5).

In the illustrated non-limiting example, the intermediate pole piece 22 can extend radially outwardly from the inner surface 73 in a direction toward the permanent magnet 20 to an outer surface 75. The outer surface 75 of the intermediate pole piece 22 defines a radially outermost plane 77 of the intermediate pole piece 22. The radially outermost plane 77 is arranged parallel to the central axis 2. The radial extension of the intermediate pole piece 22 from the inner surface 73 to the outer surface 75 in a direction toward the permanent magnet 20 reduces the required size of the permanent magnet 20. For example, in convention solenoid designs, a permanent magnet may extend radially over an entire volume defined between a housing and an armature, or another structure location radially adjacent to the armature. This design requires a large volume of permanent magnet to be included in the design, which increases costs due to the expense of manufacturing and charging permanent magnets. The design of the intermediate pole piece 22 and its extension radially outwardly reduces the required size in a radial dimension defined by the permanent magnet 20 and maintain the axial length of the permanent magnet 20 to prevent saturation.

In general, the overall reduction in the size of the permanent magnet 20 is illustrated by the relative orientation between the outermost plane 77 and an inner coil plane 79 defined along a radially innermost diameter of the wire coil 48. The inner coil plane 79 is arranged parallel to the central axis 2. In the illustrated non-limiting example, the radially outermost plane 77 is arranged radially outward relative to the inner coil plane 79. In other words, the intermediate pole piece 22 extends radially outwardly past the inner coil plane 79.

During operation, the armature 24 can be displaced between two or more stable positions to engage, either directly or indirectly, an actuation element (e.g., a pin, spool, or rod, not shown) to apply an actuation force thereto. The armature 24 can be fabricated from a magnetic material (e.g., magnetic steel, iron, nickel, etc.). In the illustrated non-limiting example, the armature 24 can include a first end 80, a second end 82, and a central aperture 84. According to some non-limiting examples, the central aperture 84 can be configured to receive the actuation element therein (e.g., a pin, spool, or rod, not shown). According to other non-limiting examples, the central aperture 84 can provide fluid communication between the first and second ends 80, 82 of the armature 24. In some non-limiting examples, the multi-stable solenoid 10 may not have an actuation element or central aperture and the armature may instead be formed of a single, solid body.

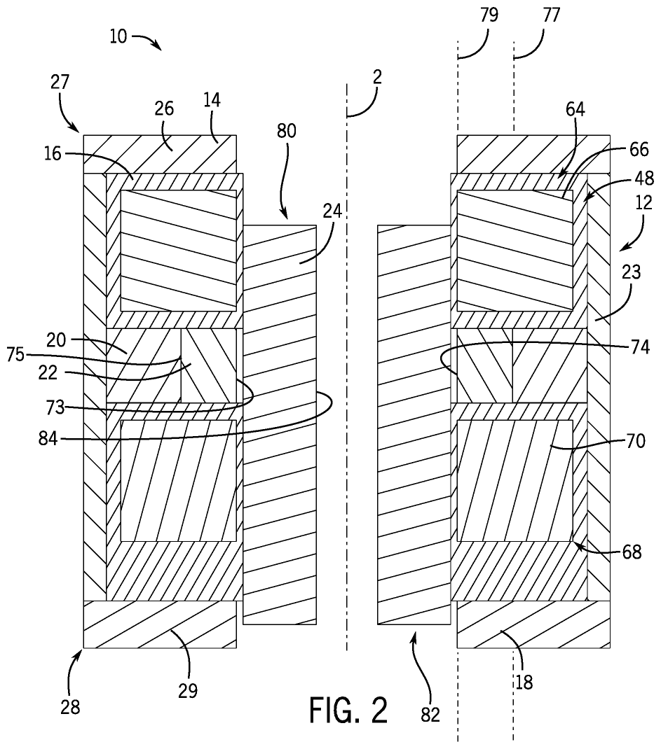

One non-limiting example of the operation of the multi-stable solenoid 10 will be described below with reference to FIGS. 1 and 2. It should be appreciated that the described operation of the multi-stable solenoid 10 can be adapted to many suitable systems. In operation, the wire coil 48 of the multi-stable solenoid 10 may be selectively energized (i.e., supplied with a current in a first direction at a predetermined magnitude). The energization of the wire coil 48 generates a force on the armature 24 and the armature 24 can move from a first stable position (FIG. 1) to a second stable position (FIG. 2). The armature 24 remains in the second stable position until the wire coil is energized (i.e., supplied with a current in a second direction at a predetermined magnitude) and the armature 24 may then move from the second stable position to the first stable position. In the illustrated non-limiting example, the armature 24 may be movable between a first position (FIG. 1) wherein the armature 24 is arranged adjacent to the first pole piece 14 and a second position (FIG. 2) where the armature 24 is arranged adjacent to the second pole piece 18. When the armature 24 is in one of the two or more stable positions, the armature 24 will remain in that position, due to the magnetic flux generated by the permanent magnet 20, until the wire coil 48 is again energized with a current. In this way, the operation of the multi-stable solenoid 10 may require a reduced energy input because the wire coil 48 does not require continuous energization to maintain the armature 24 in any one of the two or more stable positions.

FIG. 3 shows another non-limiting example of the multi-stable solenoid 10. As described herein, the radial orientation between the permanent magnet 20 and the intermediate pole piece 22 may be varied. In the illustrated embodiment of FIG. 3, the intermediate pole piece 22 is arranged radially inwardly from the permanent magnet 20.

FIG. 4 shows a multi-stable solenoid 100 according to one aspect of the present disclosure. In the following description and corresponding figures, similar elements will be labeled using like reference numerals. In the illustrated non-limiting example, the solenoid 100 can include a housing 12 at least partially enveloping a first pole piece 114, a bobbin 16, a second pole piece 118, a permanent magnet 20, an intermediate pole piece 22 (e.g., a third pole piece), and an armature 24. The components of the solenoid 10 may be aligned along a central axis 2. As will be described herein, the arrangement of the multi-stable solenoid 100 with the intermediate pole piece 22 may enable a reduction in the overall size of the permanent magnet 20, allow magnetic flux to flow more readily into an armature 24, and allow for a reduction in the overall size of the solenoid 100, when compared to conventional solenoid designs.

In the illustrated non-limiting example, the housing 12 can define a generally hollow, cylindrical shape and can include a cylindrical sleeve 23, a first flange 26 at a first end 27 of the housing 12. Opposite the first end 27, the housing 12 can include a second flange 29 at a second end 28 of the housing 12. Together the cylindrical sleeve 23, the first flange 26, and the second flange 29 create an enclosed chamber defined by the housing 12. According to some non-limiting examples, the second flange 29 of the solenoid 100 can define a mounting flange configured to secure the solenoid 100 to a structure (e.g., a manifold, bracket, etc., not shown). According to some non-limiting examples, the mounting flange can include one or more fastener apertures extending through the mounting flange. The fastener apertures can receive a fastener therethrough to attach the solenoid 100 to the structure.

In some non-limiting examples, the armature 24 of the solenoid 100 may be coupled to an actuation element 25 (e.g., a pin, pushrod, etc.). The armature 24 may be configured to selectively displace the actuation element 25. The illustrated actuation element 25 is in the form of a pin and is provided as an example and is in no way meant to be limiting. It will be understood to those skilled in the art that the disclosed solenoid 100, including the armature 24, can be used in any suitable arrangement to provide an actuation force to a device. In any case, the armature 24 and the actuation element 25 coupled thereto can be selectively displaced by selective energization of the wire coil 48 to apply an actuation force.

The first pole piece 114 can be fabricated from a magnetic material (e.g., magnetic steel, iron, nickel, etc.). The first pole piece 114 can be disposed at least partially within the housing 12 adjacent to the first end 27. As illustrated in FIG. 4, the first pole piece 114 can extend at least partially through to the first flange 26 and axially away from the first end 27 of the housing 12. The first pole piece 114 can include a first armature-receiving portion 36 in the form of an axial projection extending away from the first end 27 of the housing 12 toward the second end 28. The first armature-receiving portion 36 can be disposed at a first end 38 of the first pole piece 114 and can include a first armature-receiving recess 40 configured to receive the armature 24. As illustrated in FIG. 4, the first armature-receiving portion 36 may define a first base surface 42 within the first armature-receiving recess 40. The first base surface 42 of the first armature-receiving recess 40 can act as a first end stop for the armature 24. In addition, the first pole piece 114 can include a first pin-engaging aperture 43. The first pin-engaging aperture 43 can extend through a second end 47 of the first pole piece 114 and can be configured to slidably receive the actuation element 25 therethrough.

The second pole piece 118 can be fabricated from a magnetic material (e.g., magnetic steel, iron, nickel, etc.). The second pole piece 118 can be disposed partially within the housing 12 and axially separated from the first pole piece 114. The second pole piece 118 can extend at least partially through the second flange 29 and can be coupled to the second flange 29. The second pole piece 118 can also include a second armature-receiving portion 54 in the form of an axial projection extending away from the second end 28 of the housing 12 towards the first end 27. The second armature-receiving portion 54 can be disposed at a first end 56 of the second pole piece 118 and can include a second armature-receiving recess 58 configured to receive the armature 24. As illustrated in FIG. 4, the second armature-receiving portion 54 may define a second base surface 60 within the second armature-receiving recess 58. The second base surface 60 of the second armature-receiving recess 58 can act as a second end stop for the armature 24. In addition, the second pole piece 118 can include a second pin-engaging aperture 61. The second pin-engaging aperture 61 can extend through a second end 63 of the second pole piece 118 and can be configured to slidably receive the actuation element 25 therethrough.

The bobbin 16 can be fabricated from a non-magnetic material (e.g., plastic) and can define a first bobbin portion 64 that can be arranged adjacent to the first end 27 of the housing 12. The first bobbin portion 64 can define a generally annular shape and can surround at least a portion of the first pole piece 114. A first coil bay 66 of a wire coil 48 may be wound around the first bobbin portion 64. The bobbin 16 can also define a second bobbin portion 68 arranged adjacent to the second end 28 of the housing 12. The second bobbin portion 68 can define a generally annular shape and can surround at least a portion of the second pole piece 118. A second coil bay 70 of the wire coil 48 may be wound around the second bobbin portion 68.

The permanent magnet 20 can define a generally annular shape and can be disposed within the housing 12 between the first bobbin portion 64 and the second bobbin portion 68. In the illustrated arrangement, the permanent magnet 20 is radially charged. That is, the north and south poles of the permanent magnet 20 may be aligned in a radial direction (e.g., a direction perpendicular to the central axis 2). That is, the first coil bay 66 and the second coil bay 70 can be axially separated forming an axial gap in the bobbin 16. The permanent magnet 20 can be arranged within the axial gap between the first coil bay 66 and the second coil bay 70.

In the illustrated non-limiting example, the permanent magnet 20 is arranged radially outward from the intermediate pole piece 22, such that the intermediate pole piece 22 can be arranged in series with the permanent magnet (i.e., in the magnetic circuit all of the magnetic flux passing through the intermediate pole piece 22 also flows through the permanent magnet 20, except for loss effects). In some non-limiting examples, the solenoid 100 can include a plurality of permanent magnets 20 (see FIG. 6) arranged in a circumferential pattern within the housing 12. In the illustrated non-limiting example, a portion of the axial length of the permanent magnet 20 axially overlaps with a portion of the axial length of the intermediate pole piece 22. That is, the permanent magnet 20 may be arranged at an axial location along the central axis 2 so that the axial length defined by the permanent magnet 20 overlaps with or is arranged at the same axial location as at least a portion of the intermediate pole piece 22.

In general, the intermediate pole piece 22 may be defined with different shapes and sizes according to the components and properties of the solenoid 100. The intermediate pole piece 22 can be fabricated from a magnetic material (e.g., magnetic steel, iron, nickel, etc.). As illustrated in FIG. 4, the intermediate pole piece 22 can define a generally annular shape and can be disposed within the housing 12 axially between the first pole piece 114 and the second pole piece 118. In the illustrated non-limiting example of FIG. 4, the intermediate pole piece 22 can include a first axial protrusion 76 extending axially toward the first end 27 of the housing 12 and a second axial protrusion 78 extending axially toward the second end 28 of the housing 12. Thus, the first axial protrusion 76 and the second axial protrusion 78 may be arranged on axially opposing sides of the intermediate pole piece 22.

The intermediate pole piece 22 can also include a radial flange 81 extending radially outwardly from the intermediate pole piece 22 to meet the permanent magnet 20. The intermediate pole piece 22 includes an inner surface 73 that defines an armature opening 74 within which the armature 24 extends through. In the illustrated non-limiting example, the radial flange 81 can extend radially outwardly from the inner surface 73 in a direction toward the permanent magnet 20 to an outer surface 75. The outer surface 75 of the intermediate pole piece 22 defines a radially outermost plane 77 of the intermediate pole piece 22. The radially outermost plane 77 is arranged parallel to the central axis 2. The radial extension of the intermediate pole piece 22 from the inner surface 73 to the outer surface 75 in a direction toward the permanent magnet 20 reduces the required size of the permanent magnet 20. For example, in convention solenoid designs, a permanent magnet may extend radially over an entire volume defined between a housing and an armature, or another structure location radially adjacent to the armature. This design requires a large volume of permanent magnet to be included in the design, which increases costs due to the expense of manufacturing and charging permanent magnets. The design of the intermediate pole piece 22 and its extension radially outwardly reduces the required size in a radial dimension defined by the permanent magnet 20 and maintain the axial length of the permanent magnet 20 to prevent saturation.

In general, the overall reduction in the size of the permanent magnet 20 is illustrated by the relative orientation between the outermost plane 77 and an inner coil plane 79 defined along a radially innermost diameter of the wire coil 48. The inner coil plane 79 is arranged parallel to the central axis 2. In the illustrated non-limiting example, the radially outermost plane 77 is arranged radially outward relative to the inner coil plane 79. In other words, the intermediate pole piece 22 extends radially outwardly past the inner coil plane 79.

In the illustrated non-limiting example, the intermediate pole piece 22 can define a generally T-shaped profile. For example, the combination of the first axial protrusion 76, the second axial protrusion 78, and the radial flange 81 may define a generally T-shaped outer periphery.

The armature 24 can be fabricated from a magnetic material (e.g., magnetic steel, iron, nickel, etc.). The armature 24 can include a first end 80, a second end 82, and a central aperture 84. During operation, the first end 80 can be configured to engage the first armature-receiving recess 40 of the first pole piece 114, and the second end 82 can be configured to engage the second armature-receiving recess 58 of the second pole piece 118. According to some non-limiting examples, the central aperture 84 can be configured to slidably receive the actuation element 25 therethrough. According to other non-limiting examples, the actuation element 25 can be configured to move with the armature 24 (i.e., via a press-fit therebetween, or other coupling elements).

In the illustrated non-limiting example, the actuation element 25 can slidably extend through the first pole piece 114, the armature 24, and the second pole piece 118. The actuation element 25 can slidably engage the second pin-engaging aperture 61 of the second pole piece 118, the central aperture 84 of the armature 24, and the first pin-engaging aperture 43 of the first pole piece 114. In some non-limiting examples, the actuation element can be directly coupled (e.g., rigidly) to the armature 24. In some non-limiting examples, the solenoid 100 may not have an actuation element and the armature may instead be formed of a single, solid body.

One non-limiting example of the operation of the solenoid 100 will be described below with reference to FIGS. 4 and 5. It should be appreciated that the described operation of the solenoid 100 can be adapted to many suitable systems. In operation, the wire coil 48 of the solenoid 100 may be selectively energized (i.e., supplied with a current in a first direction at a predetermined magnitude), and, in response to the current being applied to the wire coil 48, the armature 24 can move from a first stable position (FIG. 4) to a second stable position (FIG. 5). The armature 24 remains in the second stable position until the wire coil is energized (i.e., supplied with a current in a second direction at a predetermined magnitude) and the armature 24 may then move from the second stable position to the first stable position. In the illustrated non-limiting example, the armature 24 may be movable between a first position (FIG. 4), where the armature 24 engages the first base surface 42 of the first armature-receiving recess 40 of the first pole piece 114, and a second position (FIG. 5) where the armature 24 contacts the second base surface 60 of the second armature-receiving recess 58 of the second pole piece 118.

In one example of operation, the armature 24 may be in the first position and the wire coil 48 of the solenoid 100 may be energized with a current in a first direction. The armature 24 may then fully shift (i.e., actuate) towards the second position until the armature 24 contacts the second base surface 60 of the second pole piece 118, at which point the armature 24 is in the second position and the wire coil 48 may be de-energized (i.e., the current is removed and the armature is in a stable position). The armature 24 will remain in the second position, due to the magnetic flux generated by the permanent magnet 20, until the wire coil 48 is energized with a current in the second direction opposite to the first direction. The armature 24 may then fully shift back towards the first position until the armature 24 contacts the first base surface 42 of the first pole piece 114, at which point the armature 24 is in the first position and the wire coil 48 may be de-energized. In this way, the operation of the solenoid 100 may require a reduced energy input because the wire coil 48 does not require continuous energization to maintain the armature 24 in either one of the first or second positions.

The armature 24 may influence a position of the actuation element 25. For example, during operation, the actuation element 25 may be moved between a retracted position (FIG. 4) and an extended position (FIG. 5), in response to movement of the armature 24 between the first position and the second position.

The arrangement of the solenoid 100 described herein may enable benefits or improvements over conventional solenoids. For example, as described herein, the intermediate pole piece 22 is arranged within the solenoid 100 to reduce a required volume defined by the permanent magnet 20. In general, as the size of a solenoid increases, so must the size of the permanent magnet, especially in applications that require a large housing diameter. As the size of the permanent magnet increases, the magnetic strength thereof also increases, which can negatively affect operation of multi-stable solenoids by creating areas of saturation and increasing hold forces in the stable positions, which increases the required force to move the armature and increases the cost of manufacturing the solenoid.

The solenoid 100 described herein overcomes these design issues by utilizing the intermediate pole piece 22 that extends radially outwardly to reduce the required size in a radial dimension defined by the permanent magnet 20 and maintain the axial length of the permanent magnet 20 to prevent saturation. The reduction in the required size of the permanent magnet 20 can reduce the cost of the solenoid 100 because the total volume defined by the permanent magnet 20 is reduced when compared to conventional solenoid designs (e.g., where a permanent magnet extends radially over an entire volume between an armature and a housing). In addition, the amount of radial extension defined by the intermediate pole piece 22 can be tailored to fit a particular solenoid design (e.g., axial length, housing diameter, etc.) without needing to alter geometry defined by the permanent magnet 20, which substantially negates saturation issues from changing the geometry of the permanent magnet 20 to fit a given solenoid design.

Further, due to the intermediate pole piece 22 being made of a magnetic material, the magnetic flux can flow more readily into the armature 24, and the T-shaped profile of the intermediate pole piece 22 described herein increases the engagement of the intermediate pole piece 22 with the armature 24. This increased engagement can enable the solenoid 100 to have longer armature stroke lengths while still maintaining the armature 24 in one of the first or second stable positions, which can also reduce an overall height of the solenoid 100. In addition, the solenoid 100 can also increase the force across the entire stroke of the armature 24 because the intermediate pole piece 22 has more engagement with the armature 24 to reduce the “NI” losses (i.e., losses in the current of the windings of the coil). Further still, the solenoid 100 can reduce saturation in the armature 24 because the intermediate pole piece 22 is a shared flux path, with the exception for the short axial distance between the first/second pole pieces 114, 118 and the axial protrusions 76, 78 of the intermediate pole piece 22.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

I claim:

1. A multi-stable solenoid comprising:
a housing defining a first end and an opposing second end;
a wire coil arranged within the housing and defining an inner coil plane defined along a radially innermost diameter of the wire coil;
a first pole piece arranged adjacent to the first end of the housing;
a second pole piece arranged adjacent to the second end of the housing;
an intermediate pole piece arranged axially between the first pole piece and the second pole piece, wherein the intermediate pole piece extends radially outwardly past the inner coil plane to an outer surface;
a permanent magnet arranged adjacent to the intermediate pole piece; and
an armature slidably arranged within the housing and movable between two or more stable positions, wherein selective energization of the wire coil is configured to move the armature between the two or more stable positions.

2. The multi-stable solenoid of claim 1, wherein the permanent magnet is radially charged.

3. The multi-stable solenoid of claim 1, wherein the intermediate pole piece is arranged in series with the permanent magnet.

4. The multi-stable solenoid of claim 1, wherein at least a portion of the intermediate pole piece axially overlaps with the permanent magnet.

5. The multi-stable solenoid of claim 1, wherein the intermediate pole piece includes a first axial protrusion and a second axial protrusion extending axially from the intermediate pole piece in opposing directions.

6. The multi-stable solenoid of claim 5, wherein the intermediate pole piece includes a radial flange that extends radially outwardly from an inner surface to the outer surface.

7. The multi-stable solenoid of claim 6, wherein the first axial protrusion, the second axial protrusion, and the radial flange define a T-shaped outer periphery of the intermediate pole piece.

8. A multi-stable solenoid comprising:
a housing;
a wire coil arranged within the housing and defining an inner coil plane defined along a radially innermost diameter of the wire coil;
a first pole piece arranged at least partially within the housing;
a second pole piece arranged at least partially within the housing;
a permanent magnet arranged within the housing;
an intermediate pole piece arranged axially between the first pole piece and the second pole piece and axially aligned with the permanent magnet, wherein the intermediate pole piece defines a radially outermost plane that is arranged radially outwardly relative to the inner coil plane; and
an armature arranged within the housing and slidably movable between at least a first stable position and a second stable position, wherein selective energization of the wire coil is configured to move the armature between the first stable position and the second stable position.

9. The multi-stable solenoid of claim 8, wherein, when the armature is in the first stable position, the armature is engaged with the first pole piece and when the armature is in the second stable position, the armature is engaged with the second pole piece.

10. The multi-stable solenoid of claim 8, wherein the intermediate pole piece includes a first axial protrusion and a second axial protrusion extending axially from the intermediate pole piece on opposing sides thereof.

11. The multi-stable solenoid of claim 8, wherein the permanent magnet is radially charged.

12. The multi-stable solenoid of claim 8, wherein the intermediate pole piece is arranged in series with the permanent magnet.

13. The multi-stable solenoid of claim 12, wherein the intermediate pole piece includes a first axial protrusion and a second axial protrusion extending axially from the intermediate pole piece in opposing directions.

14. The multi-stable solenoid of claim 13, wherein the intermediate pole piece includes a radial flange that extends radially outwardly from an inner surface to an outer surface, and wherein the outer surface defines the radially outermost plane.

15. The multi-stable solenoid of claim 14, wherein the first axial protrusion, the second axial protrusion, and the radial flange define a T-shaped outer periphery of the intermediate pole piece.

16. A multi-stable solenoid comprising:
a housing defining a first end and an opposing second end;
a wire coil arranged within the housing;
a first pole piece arranged adjacent to the first end of the housing;
a second pole piece arranged adjacent to the second end of the housing;
an intermediate pole piece arranged axially between the first pole piece and the second pole piece, wherein the intermediate pole piece defines a T-shaped profile formed by a first axial protrusion, a second axial protrusion, and a radial flange;
a permanent magnet arranged between the first pole piece and the second pole piece and axially aligned with the intermediate pole piece; and
an armature movable between two or more stable positions, wherein selective energization of the wire coil is configured to actuate the armature between the two or more stable positions.

17. The multi-stable solenoid of claim 16, wherein the wire coil defines an inner coil plane defined along a radially innermost diameter of the wire coil.

18. The multi-stable solenoid of claim 17, wherein the intermediate pole piece defines a radially outermost plane that is arranged radially outwardly relative to the inner coil plane.

19. The multi-stable solenoid of claim 17, wherein the intermediate pole piece extends radially outwardly past the inner coil plane to an outer surface.

20. The multi-stable solenoid of claim 16, wherein the intermediate pole piece is arranged in series with the permanent magnet.
